(19) United States
(12) Patent Application Publication
(10) Pub. No.: US 2008/0174573 A1
(43) Pub. Date: Jul. 24, 2008

(54) Method and System for PC Monitor Phase Locking In Changing Content Environments

(76) Inventor: Charles T. Monahan, Mountain View, CA (US)

Correspondence Address: MCANDREWS HELD & MALLOY, LTD, 500 WEST MADISON STREET, SUITE 3400, CHICAGO, IL, 60661, US

(21) Appl. No.: 11/626,438

(22) Filed: Jan. 24, 2007

(51) Int. Cl. G09G 5/00

(52) U.S. Cl. 345/204

(57) ABSTRACT

Aspects of a method and system for PC monitor phase locking in changing content environments may include phase-locking video signals at a PC monitor signal receiver, based on locating amplitude transitions for one or more of the video signals. The amplitude transitions may be identified by comparing an amplitude difference of two or more samples with a threshold for at least one of the video signals. The two or more samples may be separated by one pixel period and the threshold may be a variable parameter. Phase-offset samples and non-phase-offset samples of the video signals may be generated by sampling at phase-offset sampling instances and non-phase-offset sampling instances, respectively. The mean normalized rate of change of the phase-offset samples and the non-phase-offset samples may be analyzed to allow locating the amplitude transitions of the video signals. The beginning of the amplitude transitions may be located by using a target index.

### CROSS-REFERENCE TO RELATED APPLICATIONS/INCORPORATION BY REFERENCE

None.

### FIELD OF THE INVENTION

Certain embodiments of the invention relate to signal processing and electronic circuit design. More specifically, certain embodiments of the invention relate to a method and system for PC monitor phase locking in changing content environments.

### BACKGROUND OF THE INVENTION

Transmitting two-dimensional pictures electronically requires the handling of large amounts of information. Typically, a picture is sliced into horizontal strips—video lines—and a stack of horizontal strips is transmitted sequentially, that is, one line after another. At the receiving end, the picture is recreated on the display by drawing all the lines sequentially on the display device. This process continues until all the lines that make up the picture have been drawn. Each complete picture refresh is called a frame. Typical refresh rates vary from about 25 frames/second to about 70 frames/second, depending on the video application.

In order to ensure that the frame and the video lines are correctly placed on the display, synchronization (sync, for short) signals are used. A Horizontal Sync (HSync) signal is used to tell the receiver that a video line is finished and that it should start drawing the next video line at the left edge of the display, below the line just completed. A Vertical Sync (VSync) signal is used to indicate to the receiver that the bottom of a frame has been reached and that the next line should be drawn again at the top of the display device.

In modern PC monitors, each video line to be drawn is made up of a number of pixels so that the analog video signal is sampled to assign a discrete value to each pixel. Monochrome systems only require one video signal that carries information about the brightness of each pixel, plus the synchronization signals described above. Color computer systems, on the other hand, require one signal for each color component, where the colors transmitted are red, green and blue. The combination of these three primary colors in different intensities permits the creation of a large number of colors. This is also known as the RGB color model. Since a full color video signal for a PC monitor carries five signal components, namely red, green, and blue and the two synchronization channels, this type of video is often referred to as RGB component video.

For PC monitors, the signal source in the computer is generally located close to the monitor and the five signal components can be transmitted on five separate wires. Other modes of transmission do exist whereby the sync signals are generally somehow combined with one or more of the color channels. This is primarily a question of convenience in applications where the video cable might be longer and there is an advantage of using fewer wires. Other than slightly different handling of the video sync signals, there is no difference in the information carried.

Current methods of handling the phase synchronization of PC monitors rely on the assumption that the input video signal is very slowly changing. Indeed, a typical PC monitor displaying a spreadsheet, a word processing document or an electronic desktop displays a picture that is essentially static in comparison to a frame refresh rate that may be in the order of 50-70 frames/second.

The use of computer video support formats to display entertainment content is partly driven by technological advances in display technology such as Liquid Crystal Displays (LCD), Plasma screens and other recent display technologies. In addition, the provision of High-Definition (HD) video content, computer games and the increasing availability of entertainment content on the Internet are also driving forces in the adoption of computer video input support. This type of content consists mostly of moving pictures, however, and no longer supports the assumption of quasi-static images required for frame and line synchronization acquisition. Hence, inaccurate of false phase locking may result.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for PC monitor phase locking in changing content environments, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 shows an exemplary interlaced video frame structure, illustrating the Hsync and Vsync synchronization signals, which may be utilized in connection with an embodiment of the invention.

FIG. 2 illustrates an exemplary analog color channel video line signal for a PC monitor, in connection with an embodiment of the invention.

FIG. 3 illustrates an exemplary analog color channel video line where the pixel period sampling clock is not aligned with the stable interval, in connection with an embodiment of the invention.

FIG. 4 is a flow diagram illustrating exemplary steps for processing PC monitor signals that may achieve phase locking, in accordance with an embodiment of the invention.

FIG. 5 shows an exemplary analog input processing block, in accordance with an embodiment of the invention.

FIG. 6 illustrates an exemplary phase locking implementation, in accordance with an embodiment of the invention.

FIG. 7 is a block diagram of an exemplary implementation of a delta block for L=4 and K=11, in accordance with an embodiment of the innovation.

### DETAILED DESCRIPTION OF THE INVENTION

Certain embodiments of the invention may be found in a method and system for PC monitor phase locking in changing content environments. Aspects of a method and system for PC monitor phase locking in changing content environments may include phase-locking video signals at a PC monitor signal receiver, based on locating amplitude transitions for one or more of the video signals. The amplitude transitions may be identified by comparing an amplitude difference of two or more samples with a threshold for at least one of the video signals. The two or more samples may be separated by one pixel period and the threshold may be a variable parameter. Phase-offset samples and non-phase-offset samples of the video signals may be generated by sampling at phase-offset sampling instances and non-phase-offset sampling instances, respectively. The mean normalized rate of change of the phase-offset samples and the non-phase-offset samples may be analyzed to allow locating the amplitude transitions of the video signals. The mean normalized rate of change may be computed using the following formula:

$$if m > 0 \text{:} {B}_{m} ( l ) ⇒ {B}_{m} ( l - 1 ) + \frac{\vert p ( n - 1 + mv ) - p ( n - 1 ) \vert}{\vert p ( n ) - p ( n - 1 ) \vert}$$

$$if m < 0 \text{:} {B}_{m} ⇒ {B}_{m} ( l - 1 ) + \frac{\vert p ( n + mv ) - p ( n - 1 ) \vert}{\vert p ( n ) - p ( n - 1 ) \vert}$$

wherein m may represent a phase offset variable, v may represent a time interval, l may represent an iteration index, Bₘ may represent the bin variable associated with phase offset m, and p(n) may represent the pixel period sample p at pixel period sampling time n. The beginning of the amplitude transitions may be determined by locating a target index and the phases of the sampling times may be adjusted in accordance with the target index.

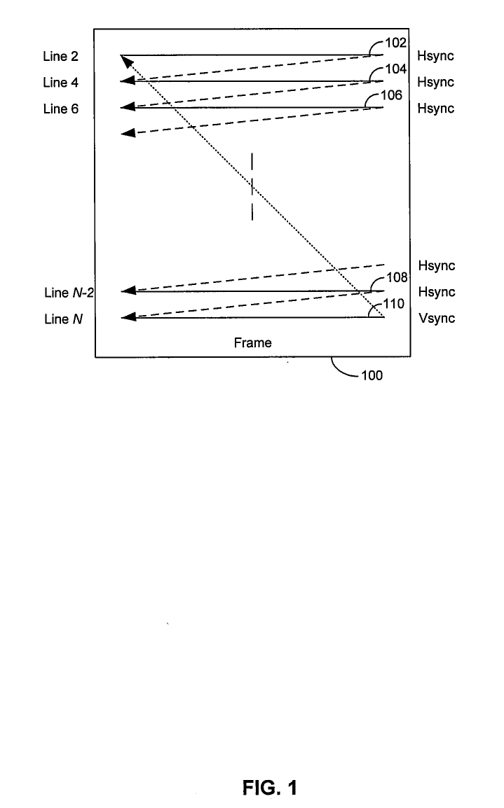

FIG. 1 shows an exemplary interlaced video frame structure, illustrating the Hsync and Vsync synchronization signals, which may be utilized in connection with an embodiment of the invention. Referring to FIG. 1, there is shown a video frame 100, comprising N video lines, of which lines 2, 4, 6, N−2 and N are shown and labeled with 102, 104, 106, 108 and 110, respectively. There are also shown the Hsync and Vsync signals. The Hsync signal may be used to signal the end of a video line. The Vsync signal may be used to signal the end of a video frame.

Standard analog video signals as may be used for PC monitors and other computer applications, may represent the two-dimensional information to display on the monitor in the form of a stack of video lines as shown in the exemplary video frame structure in FIG. 1. The end of a video line may be signaled to the monitor receiver by the horizontal synchronization signal, Hsync. The end of an entire frame may be signaled to the monitor receiver by the vertical synchronization signal, Vsync.

Referring to FIG. 1, there is depicted an example of an interlaced frame, where one frame may contain only even-numbered video line numbers of the picture and another similarly constructed frame may contain the odd-numbered video lines. The two types of frames may then be reproduced on the monitor in an alternating fashion, that is, for every frame, only half the lines may be redrawn and the two frames are interlaced, hence the name. This procedure may reduce flickering perceived by the human eye at moderate frame refresh rates.

The human eye may comprise three kinds of light receptor cones on the retina that may perceive the varying intensity of red, green and blue in an observed scene and the brain may translate the combination of these color intensities into all the different colors a human may perceive. Based on this observation, the video signal for a color PC monitor comprises a component signal for each color: red, green and blue. By using an appropriate combination of red, green and blue intensities, many colors may be represented. This type of video signal may hence be referred to as RGB component video and comprises an R (red), a G (green), a B (blue), an Hsync and a Vsync channel. With reference to FIG. 1, each color video line comprises all three color channels.

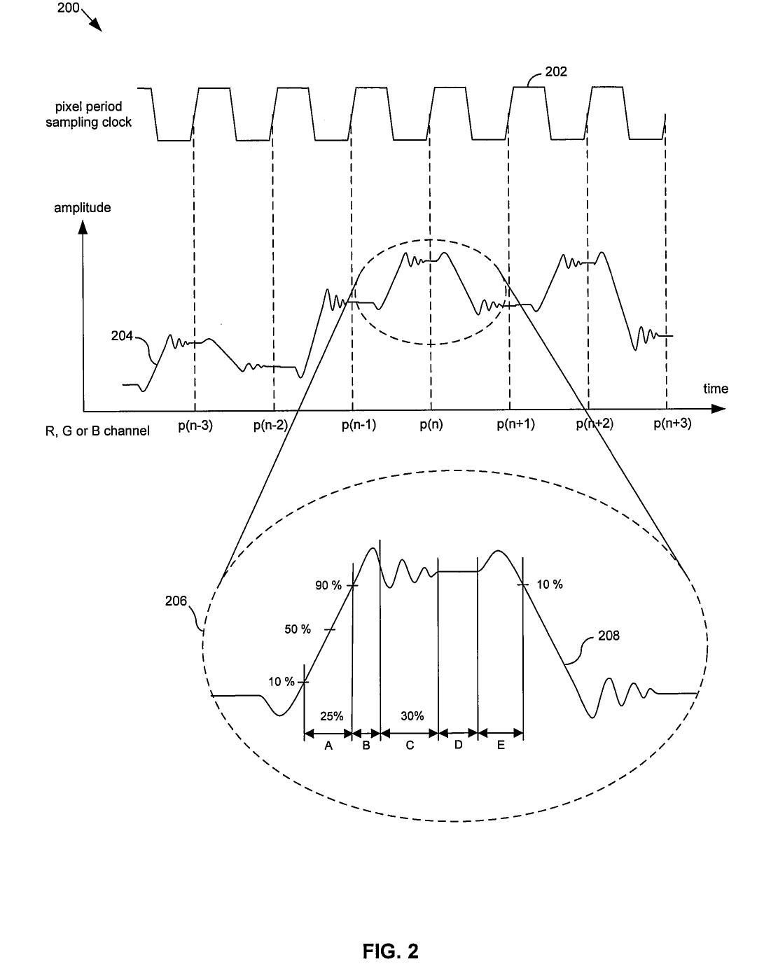

FIG. 2 illustrates an exemplary analog color channel video line signal for a PC monitor, in connection with an embodiment of the invention. Referring to FIG. 2, there is shown a pixel period sampling clock 202, a portion of an analog color channel video line (ACCVL) signal 204 and a magnified detail 206. The magnified detail 206 may comprise a portion of the ACCVL signal 208 corresponding to approximately two pixel periods of the ACCVL. There is also shown a plurality of pixel period samples p(n−3) through p(n+3) and a number of time intervals measured on a portion of the ACCVL signal 208, labeled with the letters A through E. The interval A may be used to measure the rise time, interval B may used to measure the overshoot time, interval C may be used to measure the settle time, interval D may be used to measure the stable time and interval E may be used to measure the undershoot time.

The exemplary portion of an ACCVL signal 204 illustrated in FIG. 2 may contain the data for a portion of a video line of one of the color channels, R, G or B, respectively. The other two colors may be of the same structure and type but are not illustrated. The amplitude of the ACCVL signal 204, may indicate the intensity value of the color channel. The magnified detail 208 may illustrate an exemplary transition from a lower intensity value to a higher intensity value and back to a lower intensity value. The rise time, interval A, may be defined as the time it takes the signal to rise from 10% above the previous stable amplitude to 90% of the current stable amplitude, which is stabilized in the stable interval D. The VESA VSIS Standard (Version 1, Revision 0.2), limits this transition to a duration of maximum 25% of the pixel period clock. In interval B, the time may be indicated from when the signal may overshoot the desired stable level until it may cross the stable level again. After the overshoot, the signal may oscillate around the stable level that may be achieved in interval D. The settling time may be defined as the time from the end of the overshoot interval until the signal oscillates within 5% of the stable level in interval D. The VESA VSIS standard may limit this settling time to a maximum of 30% of the pixel period. In interval D, the signal may finally have settled and the stable amplitude may indicate a stable intensity value for the color channel. As the signal may commence to transition to the next amplitude value for the next pixel, the signal may undershoot in interval E before it may decrease to more than 10% below of the stable amplitude in interval D, commencing the next transition interval.

To obtain the color's intensity value for each pixel of the line for the monitor, it may be required to sample the ACCVL 204 at a sample rate corresponding to the pixel period. Since the color intensity may be proportional to the amplitude of the sampled signal, an accurate intensity level may be obtained by sampling in the stable interval D of each pixel's waveform. If the pixel period sampling clock is synchronized to the ACCVL in this manner and the ACCVL is sampled on the rising edge of the pixel period sampling clock, we may obtain the sample values taken during the stable interval D, as depicted for a the plurality of exemplary samples p(n−3) through p(n+3).

However, as may be seen from the illustration of the analog waveform 208, the stable interval D may be a relatively small fraction of the pixel period: For example, the interval D may be 25% of the pixel period if intervals B and E each are 10% of the pixel period. Therefore, it may be important to achieve accurate synchronization timing for the pixel period sampling clock. A sampling rate and number of samples per line may be determined by one or more circuits. One or more circuits may be used to process the Hsync and Vsync synchronization signals. Finding the correct synchronization to align the pixel period sampling clock with the stable interval D may be referred to as phase locking.

In some methods and systems for phase locking, it may be assumed that the picture content as depicted for an exemplary frame in FIG. 1,1 is constant on a line-by-line or frame-by-frame basis. Under this assumption, these algorithms may perform a number of first and second order derivatives of the ACCVL signal with varying phase shifts and the stable interval is selected on the basis of a constant derivative. A problem with this approach is that the content may not be constant in time, leading to incorrect phase alignment. In accordance with various embodiments of the invention, PC monitor phase locking in changing content environments may not require the assumption of constant, non-changing content.

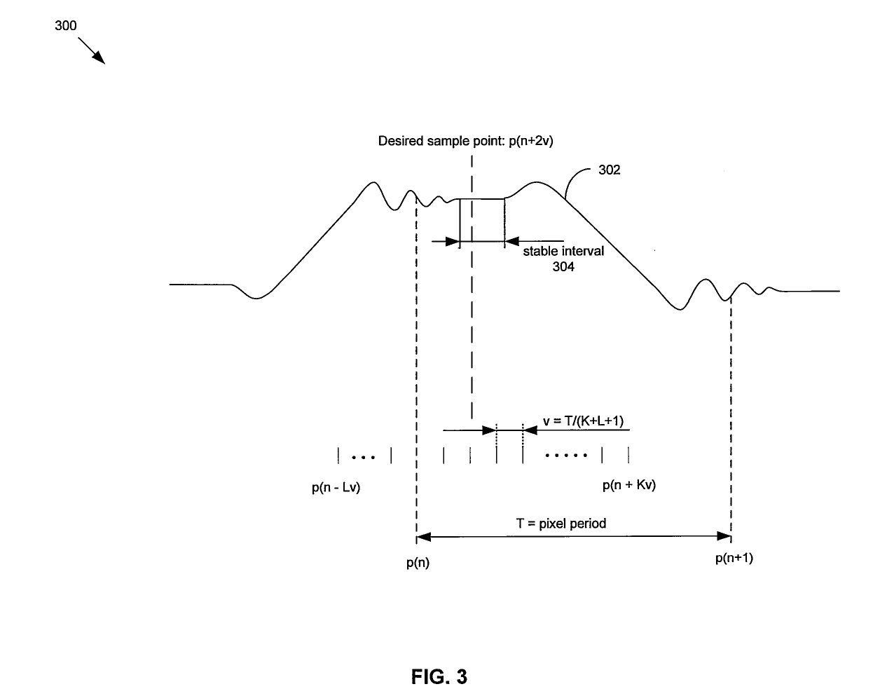

FIG. 3 illustrates an exemplary analog color channel video line where the pixel period sampling clock is not aligned with the stable interval, in connection with an embodiment of the invention. Referring to FIG. 3, there is shown an analog color channel video line 302. There are also shown the pixel period sample points p(n) and p(n+1), a stable interval 304, a phase shift period v, a pixel sample period T, and a plurality of phase shift points p(n−Lv) through p(n+Kv). L and K may be offset variables, defining the maximum positive and negative offset from sampling instant n, as illustrated in FIG. 3.

Referring to FIG. 3, it may be observed that the stable interval 304 may be followed by a transition to a new signal level, if the signal level changes between subsequent pixels, as illustrated. This observation may permit identification of the stable interval 304 as the period preceding the transition period and may help to locate the stable interval 304 if the transition period is identifiable and the transition characteristics remain similar between different pixel transitions.

As illustrated in FIG. 3, the pixel period sampling times p(n) and p(n+1) may not be aligned with the stable interval 304 before phase locking may have been achieved. By considering sampling points that may be phase shifted from the current pixel sampling time, it may be possible to find a sample time that may lie in the stable interval 304. An exemplary desired sample point is illustrated in FIG. 3, where N=K+L equally spaced phase shifts to either side of the pixel period sample p(n) have been considered, that is samples p(n−Lv) through p(n+Kv). The phase shift period v may be found as:

$$v = \frac{T}{K + L + 1}$$

Referring to FIG. 3, it may be seen that the transition may be characterized by a steep and large change in the amplitude of the signal 302. By evaluating the change characteristics of the signal 302 at a plurality of N phase shifts over the duration of a pixel period, over multiple pixel periods that may contain a transition, the transition may be identified and hence the stable interval may be located. This process of averaging the signal 302 rate of change characteristics over several pixel periods containing a transition may benefit from approximately constant transition characteristics.

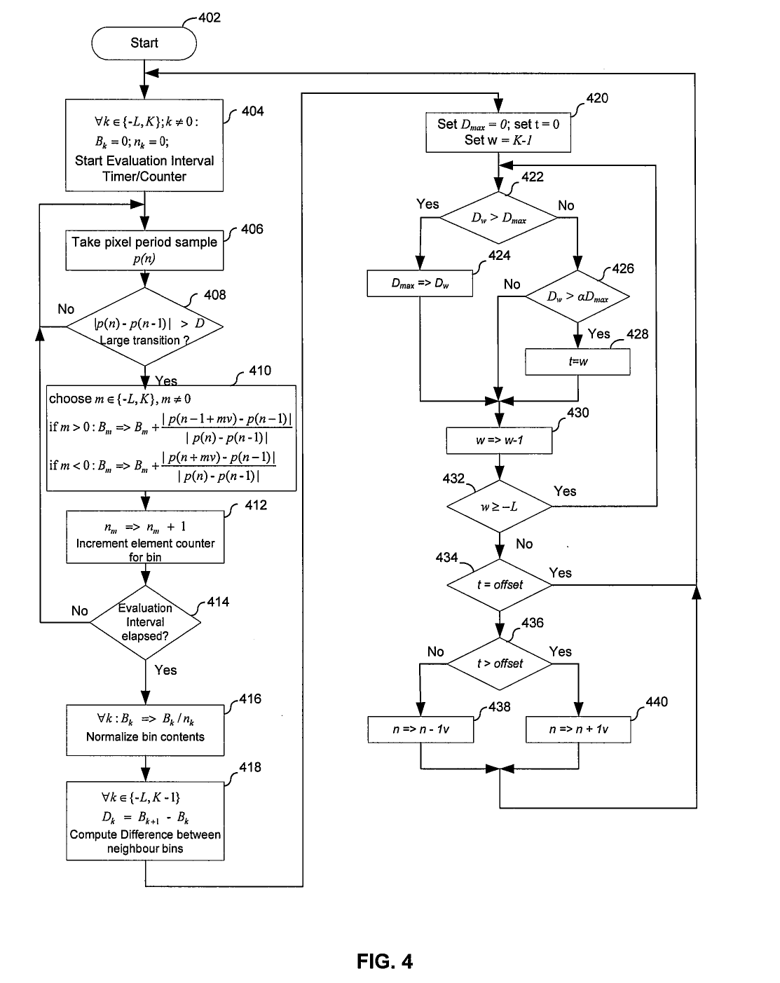

FIG. 4 is a flow diagram illustrating exemplary steps for processing PC monitor signals that may achieve phase locking, in accordance with an embodiment of the invention. Referring to FIG. 4, there is shown a start step 402, a initialization step 404, a pixel period sampling step 406, comparison steps 408, 414, 422, 426,432, 434 and 436, a variable phase measuring step 410, value assignment steps 412, 420, 424, 428 and 430, a normalizing step 416, a rate of change computing step 418, and phase adjusting steps 438 and 440.

Referring to FIG. 4, a method for achieving phase locking may be illustrated, in accordance with an embodiment of the invention. The method as illustrated may apply to a single color channel, R, G or B. The remaining two color channels may be processed in the same manner. In step 404, N bin variables Bₖ and N counter variables nₖ corresponding to each of N phase shifts from the pixel sample period may be initialized to zero. Referring to FIG. 3, for each phase shift indicated p(n+kv), where kε{−L,K},k≠0, a corresponding bin variable Bₖ and a counter variable nₖ are initialized. Also, an evaluation interval timer or counter may be initialized. This counter or timer may determine the time interval over which the transitions of an analog color channel video line signal may be analyzed in order to achieve phase locking. For example, a possible value may be the duration of an entire frame. The evaluation interval period may be a design parameter.

Referring to FIG. 4, in step 406, a pixel period sample p(n) may be taken at time nT, where T may be the pixel period and may be omitted for notational brevity and to conform to current practice. The amplitude of the current pixel sample p(n) may then be compared with the amplitude of the preceding sample taken of the last pixel, that is, p(n−1). If the difference between the samples |p(n)−p(n−1)|>D may be greater than a threshold D, we may conclude that an amplitude transition may have occurred between the pixel samples p(n) and p(n−1). If the threshold D may not have been exceeded, however, we may conclude that no transition or only a small transition may have occurred between p(n−1) and p(n). It may then be required to go back to step 406 and obtain a new pixel period sample, until a transition may be detected between two subsequent pixel period samples.

In instances where a transition is detected in step 408, a variable m≠0 may be chosen in step 410 from the interval −L to K, where m may represent a phase shift from p(n) or p(n−1) to a sampling position between p(n−1) and p(n). The normalized amplitude difference between the sample p(n−1) to the sampling position indicated by the phase shift mv may then computed and added to the corresponding bin, Bₘ. In addition, the counter variable nₘ associated with phase shift mv, may be incremented by one in step 412, thereby indicating that an additional value may have been added to the old bin value. The counter value nₘ may be necessary to compute the sample mean of the rate of change, as may be seen in the description of step 416 below.

The computation of the amplitude difference between the pixel period sample and the position indicated by the phase shift mv may be complicated by the fact that m may be positive or negative. Notwithstanding, the phase shift mv may be applied with reference to either p(n) or p(n−1) in a manner so that the phase shifted sample position indicated by mv may lie between p(n−1) and p(n). This may ensure that a portion of the transition may be sampled, regardless of the exact position of the transition between p(n−1) and p(n). This may be seen from FIG. 3. Hence, the bin values may be updated as follows:

$$if m > 0 \text{:} {B}_{m} ( l ) = {B}_{m} ( l - 1 ) + \frac{\vert p ( n - 1 + mv ) - p ( n - 1 ) \vert}{\vert p ( n ) - p ( n - 1 ) \vert}$$

$$if m < 0 \text{:} {B}_{m} ( l ) = {B}_{m} ( l - 1 ) + \frac{\vert p ( n + mv ) - p ( n - 1 ) \vert}{\vert p ( n ) - p ( n - 1 ) \vert}$$

where l may be an iteration index.

In the description of step 410 above, a single phase shift based on value m may have been chosen and a single bin Bₘ may have been updated for the transition between p(n−1) and p(n), as described above in step 410. It may be noted that the same process described above for steps 410 and 412 may be performed for multiple phase shifts in parallel. Samples may be taken for all N=K+L variable phase shift positions during a single transition, as illustrated in FIG. 3. Various embodiments of the invention may select updating from 1 to N=K+L bins per transition; However, implementation complexity may increase as number of bins being processed in parallel increases.

Choosing the phase shift value m may be achieved in a plurality of ways. In one embodiment of the invention, the value m may be chosen in a round-robin fashion, where the sequence of phase shift values m may be predetermined. In another embodiment of the invention, the phase shift value m may be chosen in an arbitrary or random order. While it may be noted that the performance of the invention may depend to some extent on the choice of algorithm to choose m, any algorithm for choosing m may be utilized.

In step 414, it may be verified whether the evaluation interval may have elapsed. As mentioned earlier, the evaluation interval may be a timer or a counter that may indicate the duration over which transitions are evaluated. The evaluation period may be chosen a frame length or any other suitable time interval or counter value.

Once the evaluation interval may have elapsed in step 414, values contained in the bin variables Bₖ are normalized, that is, the accumulated values in the bin Bₖ may be divided by the number of entries added to the bin, nₖ. This operation may be performed for bins corresponding to values of k: ∀k: Bₖ=>Bₖ/nₖ. After performing this operation, each bin may contain the sample mean of the measured normalized differences over the evaluation period.

In step 418, the rate of change between the bins corresponding to neighboring variable phase sampling positions may be computed, that is ∀kε{−L,K−1}:Dₖ=Bₖ₊₁−Bₖ. The rate of change contained in the variables Dₖ may approximate the mean steepness of the signal between neighboring variable phase sampling points.

In order to locate the end of a transition, a maximum rate of change may be determined by identifying the maximum

$${D}_{max} = {max}_{k} \{ {D}_{k} \} .$$

Also, the beginning of a transition may be identified by finding a Dₖ exceeding a threshold that may be located at the earliest absolute time before Dₘₐₓ. The phase shift corresponding to the beginning of the transition may be called t. The operations identified above may be performed by steps 420 through 432.

In step 420, the search algorithm may be initialized by setting Dₘₐₓ=0, t=0 and w=K−1. In step 422, D_{w} may be compared with the currently set Dₘₐₓ. If D_{w}>Dₘₐₓ, Dₘₐₓ may be set to the new value of D_{w}, in step 424. If D_{w}<Dₘₐₓ in step 422, D_{w} may be compared with the threshold αDₘₐₓ in step 426, to determine whether D_{w} may be a possible target index value. If in step 426, the threshold is exceeded, the target index value t may be set to the value of w, in step 428. If in step 426, the threshold has not been exceeded, the current target index value may remain unchanged. The index w may then decremented in step 430 and if w≧−L in step 432, the next iteration in the search algorithm may be initiated in step 422. This search algorithm may ensure that, upon termination of the search loop in step 432, the target index t will be set to the index k corresponding to the left-most (earliest in time) Dₖ>αDₘₐₓ. This index may then point to the beginning of the transition period.

Based on the observation made earlier that a transition may be preceded by the stable interval and that the transition characteristics may be considered constant, the position of the stable interval may be estimated to be a certain time offset before the beginning of the transition, which may have been identified by the target index t. The time offset may be a positive multiple of the variable phase period v such that timeoffset=offset·v. Optimally, the pixel period sampling period may coincide with the sampling time indicated by the index t-offset. In this case, the pixel period samples p(n) coincide with the stable interval. Hence, in step 434, if t=offset, it may be concluded that p(n) may already be located within the stable interval and no phase adjustment for the pixel period sample p(n) may need to be made. The evaluation may start again in step 404. On the other hand, if t>offset in step 436, it may be concluded that the stable interval occurs at a later time than the current pixel period sample p(n) and adjust the pixel period sampling time nT to become nT+1v. If t<offset in step 436, it may be concluded that the stable interval occurs at an earlier time than the current pixel period sample p(n) and adjust the pixel period sampling time nT to become nT−1v. When the pixel period sampling time has been adjusted, the evaluation may recommence in step 404. The pixel period sampling time may be incremented in the right direction rather than directly set to the time indicated by t-offset. This procedure may be chosen in order to avoid abrupt changes in the pixel period sampling time.

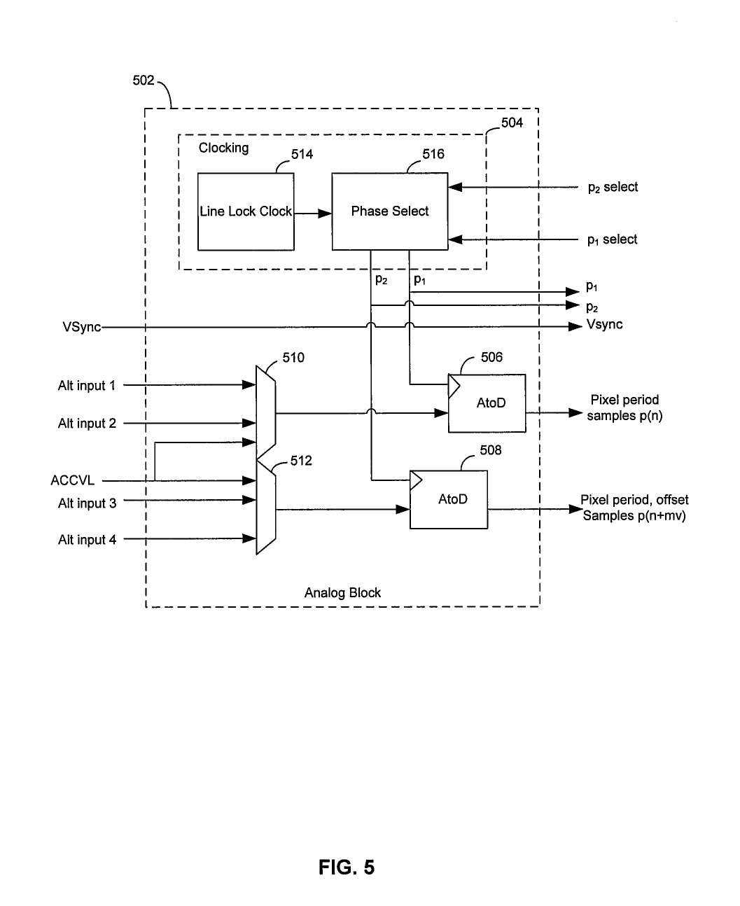

FIG. 5 shows an exemplary analog input processing block, in accordance with an embodiment of the invention. Referring to FIG. 5, there is shown an analog block 502, a clocking block 504, analog-to-digital (AtoD) converters 506 and 508, and signal multiplexers 510 and 512. The clocking block 504 may comprise a line lock clock 514 and a phase selecting block 516. There is also shown a phase 1 (p₁) select, a p₂ select signal, a vertical synchronization (Vsync) signal, a pixel period sample, a pixel period offset sample, an analog color channel video line (ACCVL) input and a plurality of alternative (Alt) inputs, for example Alt input 1, Alt input 2, Alt input 3 and Alt input 4. Furthermore, there is shown a plurality of output signals, clock p₁, clock p₂, Vsync, samples p(n) and the offset sampled signal p(n+mv).

The clocking block 504 comprises a line lock clock 514 that may provide a pixel period clock output. In the phase select block 516, the phase of the clock may be adjusted to provide two clock outputs, p₁ and p₂. The phase of each of the two clock outputs may be adjusted individually through phase control signals p₁ select and p₂ select.

A multiplexer 510 may switch the ACCVL signal (either the red, green or blue channel) or alternative inputs Alt input 1 and Alt input 2 to the output. The ability to switch to alternative inputs may enable the AtoD converter 506, to process other signals when the analog block is not utilized for phase locking purposes. Similarly, the multiplexer block 512 may switch the same ACCVL signal or alternative inputs 3 and 4 to the output. It may be noted that both multiplexers may handle an arbitrary number of alternative inputs, in another embodiment of the invention.

During phase locking, an AtoD converter 506 may convert the analog ACCVL input coming from the multiplexer 510 to a digital signal that may be sampled at clock instances p₁. Similarly, an AtoD converter 508 may be used to obtain digital samples of the ACCVL signal at sampling instances p₂. The pixel period sample output of AtoD converter 506 may correspond to step 406 in FIG. 4, and the output of AtoD converter 508 may correspond to the offset sample p(n+mv) or p(n−1+mv), depending on the sign of the phase shift m in step 410 in FIG. 4. The phase p₁ may enable controlling the sampling time nT in FIG. 4 and the phase p₂ may be controlled by the choice of value m in step 410. In another embodiment of the invention, more multiplexer-AtoD pairs may be used to achieve more samples during a transition period, as discussed for step 410 in FIG. 4.

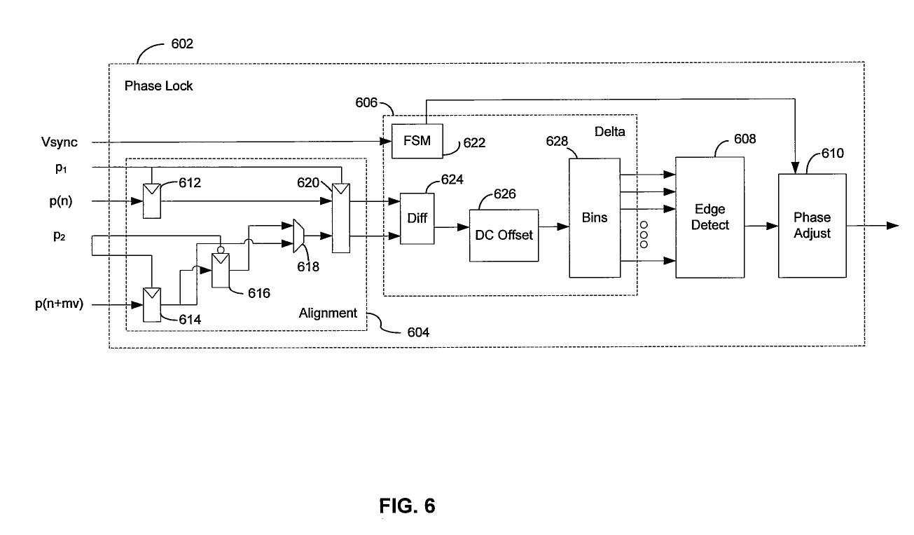

FIG. 6 illustrates an exemplary phase locking implementation, in accordance with an embodiment of the invention. Referring to FIG. 6, there is shown a phase alignment block 604, a delta block 606, an edge detection block 606 and a phase adjustment block 610. The phase alignment block 604 may comprise a plurality of single channel flip flop blocks 612, 614 and 616, a multiplexer 618 and a dual channel flip flop 620. Delta block 606 may comprise a Finite State Machine (FSM) 622, a difference block 624, a DC offset block 626 and a bins block 628. There is also shown a plurality of input signals, Vsync, p₁, p(n), p₂ and p(n+mv) corresponding to the output signals illustrated in FIG. 5.

The phase alignment block 604 may be used to align signals p(n), the sample signal, and p(n+mv), the offset sample signal that may be relayed from the analog processing block 502 shown in FIG. 5. The offset sample signal p(n+mv) may be aligned to the clock p₂ on both the rising edge in block 614 and the falling edge in block 616, for example. By properly selecting either the rising edge or the falling edge signal in the multiplexer block 618, the signal p(n+mv) may be synchronized with p(n) over a larger range of phase offsets as the p(n+mv) is clocked onto the p₁ in block 620. Hence, at the outputs of the dual channel flip-flop 620, the top branch may be p′(n) and the bottom branch may be p′(n+mv), where the prime may signify synchronous.

The delta block 606 may compute the normalized difference between the sample p(n) and the offset sample p(n+mv), and may place the result into corresponding bins, Bₘ. This may approximately correspond to steps 408 and 410 in FIG. 4. In the difference block 624, the transition may be computed according to step 408, as well as the difference |p(n)−p(n−1)|, which may be utilized for the normalization in step 410. Also, the difference between the offset sample and p(n) may be computed in the difference block 624, according to step 410. The non-normalized difference computed in the difference block 624 may be processed in a DC offset block 626. This DC offset block 626 may compensate for any difference in the DC offset level encountered at the output of the AtoD converters 506 and 508 that may otherwise introduce a constant difference term. After DC calibration may have been achieved, the difference may be normalized and update the bins Bₘ, according to step 410.

In the edge detect block 608, the contents of the bins from the bins block 628 may be normalized and may identify the transition by finding the target index t, as illustrated in steps 416 to 432. In the phase adjustment block 610, the phase of the clock p₁ may be adjusted based on the computed target index as illustrated in steps 434 to 440 in FIG. 4, that is, the phase of clock p1 may be adjusted toward the stable interval, which may represent the desired sampling interval.

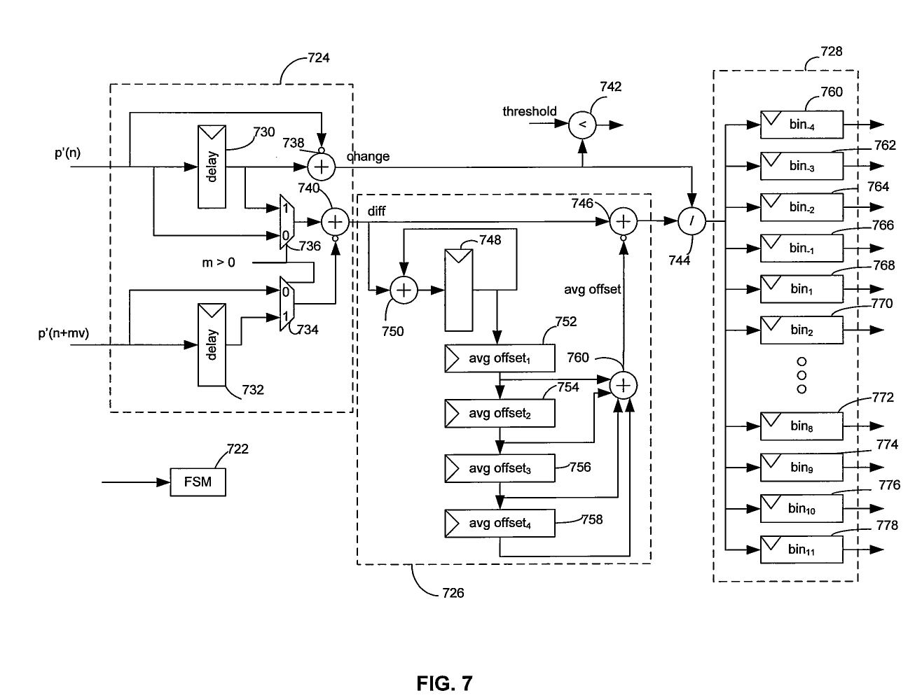

FIG. 7 is a block diagram of an exemplary implementation of a delta block for L=4 and K=11, in accordance with an embodiment of the innovation. Referring to FIG. 7, there is shown a FSM block 722, a difference block 724, a DC offset block 726, a bins block 728, a threshold comparator 742 and a normalizing block 744. The difference block 724 may comprise delay blocks 730 and 732, multiplexers 734 and 736, and summing blocks 738 and 740. The DC offset block 726 may comprise summing blocks 746, 750 and 760, a flip flop 748 and average offset blocks 752, 754, 756 and 758. The bins block 728 may comprise a bank of N−1 bins of which are shown bin₋₄ 760 through bin₂770 and bin₈ 772 through bin₁₁ 778.

The difference block 724 may enable computation of the difference between p(n) and p(n−1). The difference between p(n) and p(n+1) may be computed in block 738, and in block 742 it may be verified whether the detected difference may exceed a threshold D. This process may correspond to step 408 in FIG. 4. The delay block 732, multiplexers 734 and 736, and summing block 740 may calculate the difference |p(n−1+mv)−p(n−1)| or |p(n+mv)−p(n−1)|, depending on whether m may be positive or negative, as described for step 410 in FIG. 4. In this regard, the process may perform the difference computations associated with updating the bins in the bins block 728.

The summing blocks 746, 750 and 760, the flip flop 748 and the average offset blocks 752, 754, 756 and 758, which may comprise the DC offset block in 726, may perform the DC offset compensation as described for block 626 in FIG. 6. In this respect, DC offset block 726 may compensate for any difference in the DC offset level encountered at the output of the AtoD converters 506 and 508, as illustrated in FIG. 5. This may avoid a constant difference term due to a DC offset. After DC calibration is achieved, the difference may be normalized and the bins may be updated according to step 410 in the bins block 728.

The normalizing block 744 may enable normalization of the computed difference according to step 410 in FIG. 4. The normalized difference value may then be relayed to the bins block 728 and be utilized to update the corresponding bins.

In accordance with an embodiment of the invention, a method and system for PC monitor phase locking in changing content environments may include phase-locking video signals at a PC monitor signal receiver, based on locating amplitude transitions for one or more of the video signals, as illustrated in FIG. 4 to FIG. 7. The amplitude transitions may be identified, as shown in FIG. 3, by comparing an amplitude difference of two or more samples with a threshold for at least one of the video signals, as illustrated in steps 406-412 in FIG. 4. The two or more samples may be separated by one pixel period and the threshold may be a variable parameter, according to step 408 in FIG. 4. Phase-offset samples and non-phase-offset samples of the video signals may be generated by sampling at phase-offset sampling instances and non-phase-offset sampling instances, respectively, as shown in FIG. 3. The mean normalized rate of change, explained for step 410 in FIG. 4, of the phase-offset samples and the non-phase-offset samples may be analyzed to allow locating the amplitude transitions of the video signals. An implementation thereof may be seen in FIG. 6 and FIG. 7. The mean normalized rate of change may be computed using the following formula:

$$if m > 0 \text{:} {B}_{m} ( l ) ⇒ {B}_{m} ( l - 1 ) + \frac{\vert p ( n - 1 + mv ) - p ( n - 1 ) \vert}{\vert p ( n ) - p ( n - 1 ) \vert}$$

$$if m < 0 \text{:} {B}_{m} ⇒ {B}_{m} ( l - 1 ) + \frac{\vert p ( n + mv ) - p ( n - 1 ) \vert}{\vert p ( n ) - p ( n - 1 ) \vert}$$

wherein m may represent a phase offset variable, v may represent a time interval, l may represent an iteration index, Bₘ may represent the bin variable associated with phase offset m, and p(n) may represent the pixel period sample p at pixel period sampling time n. The beginning of the amplitude transitions may be determined by locating a target index, as shown in FIG. 4, and the phases of the sampling times may be adjusted in accordance with the target index as shown in steps 434, 436 and 438 in FIG. 4.

Another embodiment of the invention may provide a machine-readable storage, having stored thereon, a computer program having at least one code section executable by a machine, thereby causing the machine to perform the steps as described above PC monitor phase locking in changing content environments.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing video signals, the method comprising:
phase-locking at a PC monitor signal receiver, a plurality of video signals based on locating a plurality of amplitude transitions for one or more of said plurality of video signals.

2. The method according to claim 1, comprising identifying said plurality of amplitude transitions by comparing an amplitude difference of two or more samples with a threshold, for at least one of said plurality of video signals.

3. The method according to claim 2, wherein said two or more samples are separated by one pixel period.

4. The method according to claim 2, wherein said threshold is a variable parameter.

5. The method according to claim 1, comprising generating a plurality of phase-offset samples of said plurality of video signals by sampling said plurality of video signals at a plurality of phase-offset sampling instances.

6. The method according to claim 5, comprising generating a plurality of non-phase-offset samples of said plurality of video signals by sampling said plurality of video signals at a plurality of non-phase-offset sampling instances.

7. The method according to claim 6, comprising analyzing a plurality of mean normalized rate of change based on said plurality of phase-offset samples and said plurality of non-phase-offset samples to allow said locating of said plurality of amplitude transitions of said plurality of video signals.

8. The method according to claim 1, comprising analyzing a plurality of mean normalized rate of change of a plurality of phase-offset samples and a plurality of non-phase-offset samples to allow said locating of said plurality of amplitude transitions of said plurality of video signals.

9. The method according to claim 8, comprising computing said plurality of mean normalized rate of change using the following formula:
$$if m > 0 \text{:} {B}_{m} ( l ) ⇒ {B}_{m} ( l - 1 ) + \frac{\vert p ( n - 1 + mv ) - p ( n - 1 ) \vert}{\vert p ( n ) - p ( n - 1 ) \vert}$$
$$if m < 0 \text{:} {B}_{m} ⇒ {B}_{m} ( l - 1 ) + \frac{\vert p ( n + mv ) - p ( n - 1 ) \vert}{\vert p ( n ) - p ( n - 1 ) \vert}$$
wherein m represents a phase offset variable, v represents a time interval, l represents an iteration index, Bₘ represents the bin variable associated with phase offset m, and p(n) represents the pixel period sample p at pixel period sampling time n.

10. The method according to claim 8, comprising determining the beginning of said plurality of amplitude transitions by locating a target index.

11. The method according to claim 10, comprising adjusting a plurality of phases of sampling times in accordance with said target index.

12. A system for processing video signals, the system comprising:
one or more circuits for phase-locking at a PC monitor signal receiver, a plurality of video signals based on locating a plurality of amplitude transitions for one or more of said plurality of video signals.

13. The system according to claim 12, said one or more circuits identifies said plurality of amplitude transitions by comparing an amplitude difference of two or more samples with a threshold, for at least one of said plurality of video signals.

14. The system according to claim 13, wherein said two or more samples are separated by one pixel period.

15. The system according to claim 13, wherein said threshold is a variable parameter.

16. The system according to claim 12, wherein said one or more circuits generates a plurality of phase-offset samples of said plurality of video signals by sampling said plurality of video signals at a plurality of phase-offset sampling instances.

17. The system according to claim 16, wherein said one or more circuits generates a plurality of non-phase-offset samples of said plurality of video signals by sampling said plurality of video signals at a plurality of non-phase-offset sampling instances.

18. The system according to claim 17, wherein said one or more circuits analyzes a plurality of mean normalized rate of change based on said plurality of phase-offset samples and said plurality of non-phase-offset samples to allow said locating of said plurality of amplitude transitions of said plurality of video signals.

19. The system according to claim 12, wherein said one or more circuits analyzes a plurality of mean normalized rate of change of a plurality of phase-offset samples and a plurality of non-phase-offset samples to allow said locating of said plurality of amplitude transitions for said one or more of said plurality of video signals.

20. The system according to claim 19, wherein said one or more circuits computes said plurality of mean normalized rate of change using the following formula:
$$if m > 0 \text{:} {B}_{m} ( l ) ⇒ {B}_{m} ( l - 1 ) + \frac{\vert p ( n - 1 + mv ) - p ( n - 1 ) \vert}{\vert p ( n ) - p ( n - 1 ) \vert}$$
$$if m < 0 \text{:} {B}_{m} ⇒ {B}_{m} ( l - 1 ) + \frac{\vert p ( n + mv ) - p ( n - 1 ) \vert}{\vert p ( n ) - p ( n - 1 ) \vert}$$
wherein m represents a phase offset variable, v represents a time interval, l represents an iteration index, Bₘ represents the bin variable associated with phase offset m, and p(n) represents the pixel period sample p at pixel period sampling time n.

21. The system according to claim 19, wherein said one or more circuits determines a beginning of said plurality of amplitude transitions by locating a target index.

22. The system according to claim 21, wherein said one or more circuits adjusts a plurality of phases of sampling times in accordance with said target index.
